(19) United States
(12) Patent Application Publication
(10) Pub. No.: US 2024/0329328 A1
(43) Pub. Date: Oct. 3, 2024

(54) STRUCTURED BIDIRECTIONAL SYMMETRIC MULTICORE OPTICAL FIBER CABLING SYSTEM

(71) Applicant: CORNING RESEARCH & DEVELOPMENT CORPORATION, Corning, NY (US)

(72) Inventors: Douglas Llewellyn Butler, Painted Post, NY (US); Qi Wu, Painted Post, NY (US)

(21) Appl. No.: 18/191,232

(22) Filed: Mar. 28, 2023

(51) Int. Cl. G02B 6/38; G02B 6/40

(52) U.S. Cl. CPC G02B 6/3831; G02B 6/406

(57) ABSTRACT

Multicore fiber optical cabling systems and methods of making same. The cabling system includes a multicore optical fiber that is configured to carry duplex signals in symmetric core pairs. Each symmetric core pair is contained within a common cladding, and the cores of each symmetric core pair are placed symmetrically about an axis of symmetry in the end face of the optical fiber. At each end of the multicore optical fiber, one of the paired cores carries one half of a duplex optical signal, and the other core carries the other half of the duplex optical signal. The axis of symmetry of each multicore optical fiber in a connectorized cable is aligned with a key-axis of the connector. The end faces of the multicore optical fibers may be arranged in one or more rows or columns to define a high density connector interface.

### TECHNICAL FIELD

This disclosure relates generally to fiber optic connectors, cable assemblies, and structured cabling systems, and more particularly, to fiber optic connectors, cable assemblies, and structured cabling systems that include multicore optical fibers configured to carry duplex optical signals within a common cladding.

### BACKGROUND

Optical fibers are useful in a wide variety of applications, the most common being as part of the physical layer of a communication protocol through which network nodes communicate over a data network. Benefits of optical fibers include wide bandwidth and low noise operation. Continued growth of the Internet has resulted in a corresponding increase in demand for network capacity. This demand for network capacity has, in turn, generated a need for increased bandwidth between network nodes.

Multicore optical fibers are optical fibers in which multiple cores are contained within a common cladding. Multicore optical fibers function essentially as a bundle of single core fibers, thereby providing increased capacity as compared to individual single core optical fibers. Multicore optical fiber has been studied as one way to improve the transmission capacity of optical fibers in submarine and long haul applications. For short distance communications, explosive growth of hyperscale data centers, edge computing, and 5G/6G access networks has been driving demand for new fiber installations with increasingly high fiber counts and cable densities. Because the ability to increase fiber density by further reducing the diameter of single core optical fibers has reached a plateau, the deployment of multicore optical fiber is expected to increase in order to meet the growing demand for optical fiber density without expanding existing optical fiber ductwork.

To maintain compatibility with existing fiber optic ecosystems, multicore optical fiber designs typically use a cladding diameter that matches that of existing single core optical fibers, e.g., about 125 micrometers (μm). Multicore optical fibers are also typically designed to have similar optical properties as the single core optical fibers they replace. These optical properties include mode field diameter, attenuation per meter, wavelength range, bending performance, dispersion, etc. Maintaining similar physical dimensions and optical properties between multicore and single core optical fibers facilitates deployment of multicore optical fibers as a simple drop-in replacement for existing single core optical fibers.

To meet the above design constraints, the cores of multicore optical fibers being deployed in fiber optic networks are often arranged in either a 2×2 or a 1×4 configuration within a 125 μm cladding. This allows the cores to have a similar mode field diameter (e.g., ˜10 μm) as the single core fibers they interface with, while also maintaining acceptable loss specifications. Another benefit of four-core optical fiber is that its core count matches that of a parallel single mode transceiver.

Four channel parallel single mode transceivers are typically coupled to eight single core fibers. By coupling the transceiver to four-core optical fibers (either directly or through a fan-in/fan-out device), the optical fiber count can be reduced from eight to two. This allows four channel parallel single mode transceivers to be connected in much the same manner as a single duplex Coarse Wavelength Division Multiplexing (CWDM) transceiver having one channel on each of four wavelengths. Alternatively, using four-core optical fiber would allow four four-channel CWDM transceivers (16 total channels) to be operatively coupled to a single duplex fiber optic connector having two multicore optical fibers, one for each half of the duplex connection.

Although the optical fiber count in data centers can be reduced by replacing standard single core optical fiber with multicore optical fiber, large numbers of optical fibers are still needed. For example, replacing an ultra-high count fiber optic cable having 6,912 single mode optical fibers with multicore optical fibers having four cores each would still require a fiber optic cable with 1,728 multicore optical fibers. Moreover, because fusion splicing of multicore optical fibers in the field is difficult, pre-terminated structured cabling systems would provide an even more significant advantage with multicore optical fiber than they do with single core optical fiber.

Duplex patch cord cable assemblies are widely used in data center networks as part of a structured cabling system for connecting network nodes using single core optical fibers. The term “structured cabling system” is generally used to refer to cabling systems that include cable assemblies and other network components having standardized pre-terminated connection interfaces. For example, duplex transceivers are typically connected via duplex patch cords to cassettes or harnesses, which may then be connected to a trunk cable through a Multi-fiber Push On (MPO) connector. Because the receive port of each transceiver is connected to the transmission port of the other transceiver, an optical fiber polarity switch typically occurs at some point between the transceivers being connected.

TIA-568 is a technical standard issued by the Telecommunications Industry Association (TIA), and defines three methods (methods A, B, and C) for connecting transceivers using structured cabling. Method-A uses key-up to key-down straight-through MPO terminated trunk cables in which a fiber polarity switch occurs in the duplex patch cords on one side. Methods B and C use what is referred to as A-to-B type or “straight-through” duplex cables, with polarity switching occurring at the MPO trunk cables. Method-B uses key-up to key-up type B symmetric MPO terminated trunk cables, and is widely used due to its simplicity. Method C is less common, and uses pair-wise flipped type-C trunk cables. The multitude of options in single core fiber based structured cabling leads to significant complexity when migrating to multicore fiber. With multicore fiber, in addition to managing the optical fiber polarity, one must also trace the path of each core in each multicore optical fiber. Moreover, unlike single core optical fibers, cores contained within a common cladding cannot be independently placed in the connector interface to address polarity issues. The use of multicore optical fibers therefore adds a new dimension of complexity to connections between nodes in fiber optic networks.

To maintain compatibility with existing structured cabling systems, multicore optical fibers are used in a similar manner as single core optical fibers. Thus, multicore optical fibers are deployed in accordance with the TIA-568 technical standards by coupling only transmitters to one end of a multicore optical fiber and only receivers to the other end of the multicore optical fiber. Structured cabling system are thereby configured so that the optical signals carried within a single multicore optical fiber only propagate in one direction—from the transmitter end to the receiver end of the multicore optical fiber. This can lead to problems with core polarity because it requires that all cables have the same draw direction. In addition, multicore optical fibers have higher crosstalk between cores than single core optical fibers. This can reduce the distance over which optical signals can be transmitted to the point that multicore optical fiber cannot be used to replace single core optical fiber on long runs.

Accordingly, there is a need in the fiber optic industry for improved devices and methods that reduce polarity issues and crosstalk between optical signals in structured cabling systems that use multicore optical fiber.

### SUMMARY

In an aspect of the disclosure, a multicore fiber optic cabling system is disclosed. The multicore fiber optic cabling system includes a first multicore optical fiber that includes a first end face having a first axis of symmetry, a second end face having a second axis of symmetry, and a plurality of cores. The plurality of cores defines a first end face core pattern at the first end face that is symmetric about the first axis of symmetry and a second end face core pattern at the second end face that is symmetric about the second axis of symmetry. A first connector is operatively coupled to the first end face and includes a first connector interface. The first connector interface includes a first key-axis and a first connector core pattern. The first connector core pattern is defined at least in part by the first end face core pattern. A second connector is operatively coupled to the second end face and includes a second connector interface. The second connector interface includes a second key-axis and a second connector core pattern. The second connector core pattern is defined at least in part by the second end face core pattern. A third connector is configured to engage the first connector and includes a third connector interface. The third connector interface includes a third key-axis and a third connector core pattern that matches the first connector core pattern. A fourth connector is configured to engage the second connector and includes a fourth connector interface. The fourth connector interface includes a fourth key-axis and a fourth connector core pattern that matches the second connector core pattern. The first end face core pattern includes a first core and a second core placed symmetrically about the first axis of symmetry. The second end face core pattern includes the first core and the second core placed symmetrically about the second axis of symmetry. The third connector core pattern includes a third core and a fourth core placed symmetrically about a third axis of symmetry aligned with the third key-axis. The fourth connector core pattern includes a fifth core and a sixth core placed symmetrically about a fourth axis of symmetry aligned with the fourth key-axis. The first connector interface and the third connector interface are configured so that, when the first connector and the third connector are engaged, the first core receives a first optical signal from the third core and the second core transmits a second optical signal to the fourth core. The second connector interface and the fourth connector interface are configured so that, when the second connector and the fourth connector are engaged, the first core transmits the first optical signal to the fifth core and the second core receives the second optical signal from the sixth core.

In one embodiment of the disclosed cabling system, the first connector may include a first alignment key that defines the first key-axis, the second connector may include a second alignment key that defines the second key-axis, and the first end face may have the same orientation relative to the first alignment key as the second end face has relative to the second alignment key.

To aid in core referencing, each of the first end face and the second end face may further include an asymmetric feature that identifies one core of the plurality of cores as a reference core. For example, in various embodiments, the asymmetric feature may be provided by one or more of a marker, a core pattern asymmetry, or a cladding asymmetry. In one exemplary embodiment, the asymmetric feature may be provided by the marker, and the marker may be placed on the first axis of symmetry at the first end face and on the second axis of symmetry at the second end face.

The first multicore optical fiber may be one of a plurality of multicore optical fibers arranged into one or more linear arrays in each of the first connector interface and the second connector interface to respectively define the first connector core pattern and the second connector core pattern. In one embodiment, the one or more linear arrays in the first connector interface may be orthogonal to the first key-axis and the one or more linear arrays in the second connector interface may be orthogonal to the second key-axis. Moreover, in this embodiment, a first half of the plurality of multicore optical fibers in each of the one or more linear arrays may be on one side of the first key-axis in the first connector interface and the second key-axis in the second connector interface, and a second half of the plurality of multicore optical fibers in each of the one or more linear arrays may be on the other side of the first key-axis in the first connector interface and the second key-axis in the second connector interface. In a further embodiment, the one or more linear arrays in the first connector interface may be aligned with the first key-axis, and the one or more linear arrays in the second connector interface may be aligned with the second key-axis. In one embodiment, the one or more linear arrays may include a single array colinear with the first key-axis in the first connector interface and a single array colinear with the second key-axis in the second connector interface. In another embodiment, the one or more linear arrays may include an even number of arrays parallel to and having mirror-image symmetry about the first key-axis in the first connector interface, and an even number of arrays parallel to and having mirror-image symmetry about the second key-axis in the second connector interface.

In another aspect of the disclosure, a method of making the multicore fiber optic cabling system is disclosed. The method includes providing the first multicore optical fiber including the first end face having the first axis of symmetry, the second end face having the second axis of symmetry, and the plurality of cores. The plurality of cores defines the first end face core pattern at the first end face that is symmetric about the first axis of symmetry and the second end face core pattern at the second end face that is symmetric about the second axis of symmetry. The first end face core pattern includes the first core and the second core placed symmetrically about the first axis of symmetry, and the second end face core pattern includes the first core and the second core placed symmetrically about the second axis of symmetry. The method further includes operatively coupling the first connector to the first end face and the second connector to the second end face. The first connector includes the first connector interface having the first key-axis and the first connector core pattern defined at least in part by the first end face core pattern. The second connector includes the second connector interface having the second key-axis and the second connector core pattern defined at least in part by the second end face core pattern. The method further includes configuring the third connector to engage the first connector, and configuring the fourth connector to engage the second connector. The third connector includes the third connector interface having the third key-axis and the third connector core pattern that matches the first connector core pattern. The third connector core pattern includes the third core and the fourth core placed symmetrically about the third axis of symmetry aligned with the third key-axis. The fourth connector includes the fourth connector interface having the fourth key-axis and the fourth connector core pattern that matches the second connector core pattern. The fourth connector core pattern includes the fifth core and the sixth core placed symmetrically about the fourth axis of symmetry aligned with the fourth key-axis. The method further includes configuring the first connector interface and the third connector interface so that, when the first connector and the third connector are engaged, the first core receives the first optical signal from the third core and the second core transmits the second optical signal to the fourth core, and configuring the second connector interface and the fourth connector interface so that, when the second connector and the fourth connector are engaged, the first core transmits the first optical signal to the fifth core and the second core receives the second optical signal from the sixth core.

In one embodiment, the first connector may include the first alignment key that defines the first key-axis, the second connector may include the second alignment key that defines the second key-axis, and the method may further include orienting the first end face in the first connector and the second end face in the second connector so that the first end face has the same orientation relative to the first alignment key as the second end face has relative to the second alignment key.

The method may further include configuring each of the first end face and the second end face to include the asymmetric feature that identifies one core of the plurality of cores as the reference core. For example, in various embodiments, the asymmetric feature may be provided by one or more of the marker, the core pattern asymmetry, or the cladding asymmetry. In an exemplary embodiment, the asymmetric feature may be provided by the marker, and the method may further include placing the marker on the first axis of symmetry at the first end face and placing the marker on the second axis of symmetry at the second end face.

The first multicore optical fiber may be one of a plurality of multicore optical fibers, and the method may further include arranging the plurality of multicore optical fibers into one or more linear arrays in the first connector interface to define the first connector core pattern and arranging the plurality of multicore optical fibers into the one or more linear arrays in the second connector interface to define the second connector core pattern. In one embodiment, arranging the plurality of multicore optical fibers into the one or more linear arrays in the first connector interface may include arranging the one or more linear arrays to be orthogonal to the first key-axis, so that the first half of the plurality of multicore optical fibers in each of the one or more linear arrays is on one side of the first key-axis, and so that the second half of the plurality of multicore optical fibers in each of the one or more linear arrays is on the other side of the first key-axis. Moreover, in this embodiment, arranging the plurality of multicore optical fibers into the one or more linear arrays in the second connector interface may include arranging the one or more linear arrays to be orthogonal to the second key-axis, so that the first half of the plurality of multicore optical fibers in each of the one or more linear arrays is on the one side of the second key-axis, and so that the second half of the plurality of multicore optical fibers in each of the one or more linear arrays is on the other side of the second key-axis.

In one embodiment, arranging the plurality of multicore optical fibers into the one or more linear arrays in the first connector interface may include arranging the one or more linear arrays to be aligned with the first key-axis, and arranging the plurality of multicore optical fibers into the one or more linear arrays in the second connector interface may include arranging the one or more linear arrays to be aligned with the second key-axis.

In one embodiment, the one or more linear arrays may include a single array colinear with the first key-axis in the first connector interface and a single array colinear with the second key-axis in the second connector interface. In another embodiment, the one or more linear arrays may include an even number of arrays parallel to and having mirror-image symmetry about the first key-axis in the first connector interface and an even number of arrays parallel to and having mirror-image symmetry about the second key-axis in the second connector interface.

### BRIEF DESCRIPTION OF THE DRAWINGS

The accompanying drawings are included to provide a further understanding of, are incorporated in, and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a diagrammatic perspective view of an exemplary multicore optical fiber including a plurality of cores and an offset marker.

FIGS. 2-5 are diagrammatic views of multicore optical fibers each depicting an axis of symmetry and exemplary core assignments that may be used to configure the multicore fiber of FIG. 1 as a bidirectional symmetric multicore optical fiber.

FIG. 6 is a diagrammatic view the exemplary bidirectional symmetric multicore optical fiber of FIG. 2 with a symmetrically placed marker.

FIG. 7 is a diagrammatic view an exemplary bidirectional symmetric multicore optical fiber that includes a core pattern having an asymmetric feature.

FIG. 8 is a diagrammatic view depicting a multicore optical fiber in which the end face thereof lacks an asymmetric feature for identifying the axis of symmetry.

FIG. 9 is a diagrammatic view depicting a multicore optical fiber including two core pairs each placed symmetrically about a different axis of symmetry, with an X noting how one of the core pairs does not support bidirectional symmetry.

FIGS. 10 and 11 are diagrammatic views depicting a multicore optical fiber including a plurality of cores arranged in a linear array that includes two core pairs each placed symmetrically about an axis of symmetry.

FIGS. 12 and 13 are diagrammatic views of exemplary multicore patch cords including a plurality of bidirectional symmetric multicore optical fibers.

FIG. 14 is a diagrammatic view of an exemplary structured cabling system including a bidirectional symmetric multicore fiber optic trunk cable terminated by connectors having a row of multicore optical fibers.

FIG. 15 is a diagrammatic view of another exemplary structured cabling system including a bidirectional symmetric multicore fiber optic trunk cable terminated by connectors having multiple rows of multicore optical fibers.

FIG. 16 is a diagrammatic view of another exemplary structured cabling system including a bidirectional symmetric multicore fiber optic trunk cable terminated by connectors having a column of multicore optical fibers.

FIG. 17 is a diagrammatic view of another exemplary multicore structured cabling system including a bidirectional symmetric multicore fiber optic trunk cable terminated by connectors having multiple columns of multicore optical fibers.

FIG. 18 is a diagrammatic view of another exemplary multicore structured cabling system including the bidirectional symmetric multicore fiber optic trunk cable of FIG. 16 operatively coupled to a plurality of patch cords by a breakout module.

FIG. 19 is a diagrammatic view of another exemplary multicore structured cabling system including the bidirectional symmetric multicore fiber optic trunk cable of FIG. 16 operatively coupled to a plurality of fan-in/fan-out modules by the breakout module.

FIG. 20 is a diagrammatic view of one of the fan-in/fan-out modules of FIG. 19.

### DETAILED DESCRIPTION

Various embodiments will be further clarified by the examples described below. In general, the below description relates to optical fibers, fiber optic cabling systems, cable assemblies, and other fiber optic network components including one or more fiber optic connectors, which may also be referred to as “optical connector”, or simply “connector”. An optical fiber includes one or more higher refractive index regions referred to as “cores”. The one or more cores are surrounded by a lower refractive index region referred to as “cladding”. Each core and the adjacent cladding define an optical waveguide which guides light along the length thereof.

The cores within a multicore optical fiber are substantially parallel to each other such that an end face of the multicore optical fiber will have the same end face core pattern regardless of where the fiber is cleaved along its length. Two end face core patterns are considered to be the same if both the location and the polarity of each core of each core pattern are the same. If either the position or the polarity of one or more cores in the end face core patterns do not match, the end face core patterns are considered to be different.

Connectors that include one or more multicore optical fibers may have the fibers configured in an arrangement that provides a connector core pattern at the connector interface. The connector core pattern is the pattern of the cores in the multicore optical fiber arrangement at the connector interface. Thus, the connector core pattern is defined by both the end face core patterns and the placement of the end faces of the multicore optical fibers in the connector interface. Placement of the end faces refers to selecting both the position and orientation of each end face in the connector interface such that the core pattern of each end face provides a portion of the desired connector core pattern.

A bidirectional symmetric multicore optical fiber is a multicore optical fiber that includes one or more symmetric core pairs within the common cladding. A symmetric core pair refers to a pair of cores that are symmetrically placed about an axis of symmetry and which provide a duplex connection for a transceiver channel. Advantageously, bidirectional symmetric multicore optical fibers lack direction sensitivity. As described in detail below, this lack of directionality enables symmetric multicore optical fibers to be ribbonized and cabled in a similar manner as conventional single mode fibers without concern over fiber draw directions.

For the sake of brevity and clarity, the below description focuses on multicore optical fibers having four cores in a 2×2 configuration or a 1×4 configuration. However, it should be understood that multicore optical fibers having different numbers of cores in different configurations can also be used as long as they include at least one symmetric core pair.

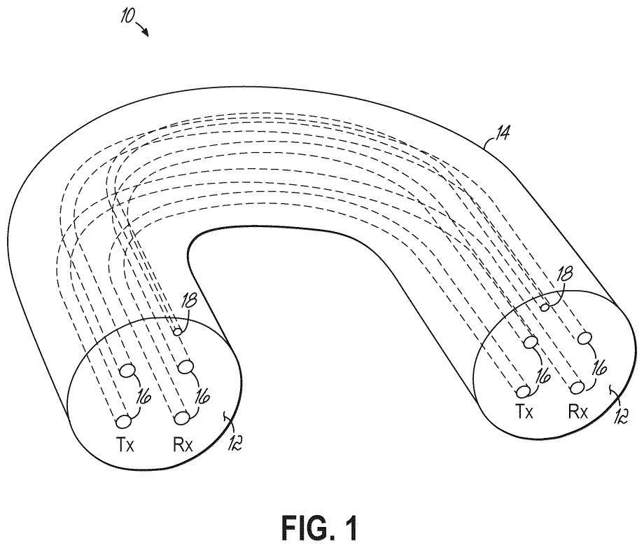

FIG. 1 depicts an exemplary multicore optical fiber 10 including front and rear end faces 12, a cladding 14, four cores 16 in a 2×2 configuration, and a marker 18. The marker 18 defines an asymmetry in the core pattern of the multicore optical fiber 10 that allows the identity of each core 16 of the multicore optical fiber 10 to be determined based on the position of the core 16 relative to a reference core 16, e.g., the core nearest the marker 18. Once the reference core 16 is identified, the remaining cores 16 can be identified based on a predetermined naming convention for the cores 16. Although the asymmetric feature of the core pattern is depicted in this and in many of the following examples as being provided by a marker 18, it should be understood that the asymmetric feature of the core pattern can also be provided by arranging the cores in an asymmetric pattern within each individual multicore optical fiber, e.g., by using an off position reference core.

The core pattern of the end faces 12 of multicore optical fiber 10 can be characterized as a square centered within the cladding 14 and having a core 16 positioned at each corner. The end face core patterns at the front and back ends of the multicore optical fiber 10 are mirror images of each other by virtue of the different perspectives from which they are depicted. The terms “front” and “back” are used herein merely in a relative sense to distinguish between different ends of a component (e.g., a multicore optical fiber, a cable assembly, etc.). The difference in perspective is due to each end face 12 being viewed from the opposite direction along the length of the multicore optical fiber 10. That is, the core pattern as viewed from the front is a mirror image of the core pattern as viewed from the back.

The asymmetric feature provided by the marker enables identification of a fiber draw direction that extends from one end face 12 (e.g., the front end face) to the other end face 12 (e.g., the back end face 12). To maintain a consistent core polarity across two connected fiber spans in a conventional fiber optic network, the multicore optical fibers 10 being connected must be oriented so that they have the same fiber draw direction. That is, core polarity is only maintained when front end faces are operatively coupled to back end faces. Multicore optical fibers which need to have the same draw direction to be connected are referred to as being direction sensitive.

The above described mirror image symmetry may be leveraged so that an optical signal operatively coupled into a selected core 16 from the transmitter module of a transceiver at one end of the multicore optical fiber 10 is provided to a receiver module of a matching transceiver at the other end of the multicore optical fiber 10, and vice-versa. Thus, optical signals launched into and received from two cores having mirror-image symmetry may be automatically connected to the same type of transceiver with each transmitter coupled to the other transceiver's receiver, and each receiver coupled to the other transceiver's transmitter. This feature is illustrated by the left column of cores 16 being labeled “Tx” and the right column of cores 16 being labeled “Rx.” A polarity flip for transceivers can thereby be automatically provided within a single multicore optical fiber through proper selection and placement of the cores. In contrast, conventional multicore structured cabling systems manage core polarity by using separate multicore optical fibers for the transmit and receive portions of each transceiver. That is, by transporting optical signals in the same direction in each core of any individual multicore optical fiber.

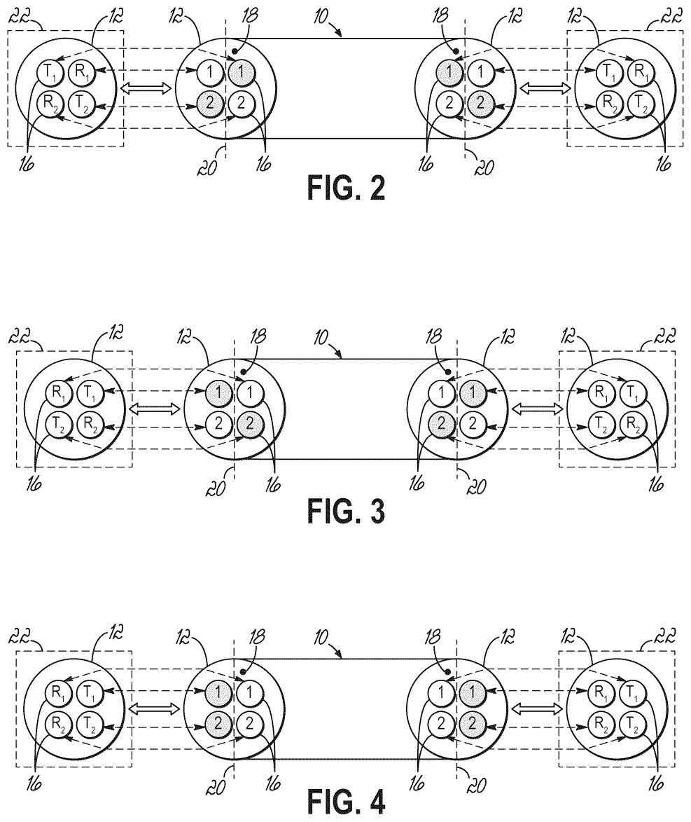

FIGS. 2-5 depict a multicore optical fiber 10 having an axis of symmetry 20 indicated by a dashed line. The axis of symmetry 20 may be defined by a line that is in a plane orthogonal to a longitudinal axis of the optical fiber, that bisects the end face 12, and that passes between the cores of each symmetric core pair. Each end of the multicore optical fiber 10 may be operatively coupled to a respective multicore optical fiber 10 of a connector interface 22 having a matching core pattern. Two core patterns match if each core in one of the core patterns is aligned with a correspondingly positioned core on the other core pattern. Core polarity is maintained across fiber spans that have matching fiber core patterns at the point where the fiber spans are operatively coupled together.

In the depicted embodiment, the core pattern of the end face 12 in each connector interface 22 has a top left core 16 assigned to a transmitter for one channel of a transceiver (referred to as channel one), a top right core 16 assigned to a receiver for channel one, a bottom left core 16 assigned to a receiver for another channel of the transceiver (referred to as channel two), and a bottom right core 16 assigned to a transmitter for channel two. For purposes of illustration only, and to facilitate identification by the reader, each core 16 of multicore optical fiber 10 is depicted with a number (e.g., “1” or “2”) that identifies cores 16 belonging to a symmetric core pair by the channel to which the core pair is assigned. Likewise, each core 16 of the connector interface 22 is depicted with a character string (e.g., T₁, T₂, R₁, or R₂) that identifies whether the core 16 is operatively coupled to a transmitter or a receiver and to which channel the respective transmitter and receiver is assigned.

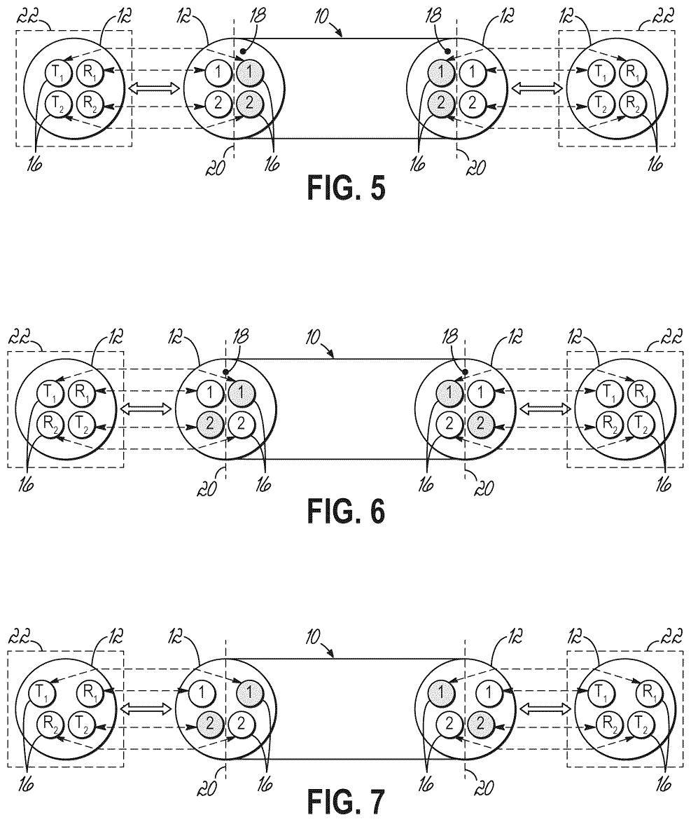

As can be seen, the transmitter and receiver cores 16 have mirror-image symmetry about the axis of symmetry 20 and define a symmetric core pair. Each symmetric core pair can be uniquely identified based on the marker 18 and the end face core pattern, and provides a full duplex link to the transceiver. Either core 16 of each symmetric core pair may be coupled to either a transmitter or a receiver of a transceiver, so long as the transceiver pattern is consistent on both ends of the multicore optical fiber 10. The transmitter and receiver cores 16 may be placed in a diagonal relationship (FIGS. 2 and 3) or in a horizontal relationship (FIGS. 4 and 5). The diagonal relationship refers to configurations in which each side of the axis of symmetry 20 includes a transmitter core 16 and a receiver core 16, and may be preferred to minimize co-propagation cross talk. The horizontal relationship refers to configurations in which both transmitter cores are on one side of the axis of symmetry 20 and both receive cores are on the other side of the axis of symmetry 20. Horizontal relationships may be used in cases where crosstalk performance is less critical, such as for relatively short distances.

FIGS. 2-5 depict each core configuration that provides a bidirectional symmetric multicore optical fiber 10 for a 2×2 multicore optical fiber having a square core pattern. Although FIGS. 2-5 are depicted with an offset marker 18, it should be understood that a marker colinear with the axis of symmetry 20 or an asymmetric core placement (described below) may also be used to identify cores in the embodiments depicted by FIGS. 2-5. For embodiments using a marker 18, it should also be understood that the marker may be located anywhere in the upper or lower half of the end face 12 of multicore optical fiber 10. Although the above core configuration parameters are described herein with respect to 1×4 and 2×2 multicore optical fibers, these core configuration parameters may also be applied to bidirectional symmetric multicore optical fibers including more than four cores.

FIG. 6 depicts an alternative embodiment of the multicore optical fiber 10 in which the marker 18 has been placed on the axis of symmetry 20. This demonstrates that the marker 18 does not need to be biased to one side of the axis of symmetry 20 to mark a particular core as the reference core. Rather, it is sufficient that the marker 18 is placed in a manner that identifies a symmetric core pair. A symmetrically positioned marker 18 as depicted in FIG. 6 provides a core identification feature by identifying the two top cores as a symmetric core pair. Advantageously, because multiple spans of multicore fiber can be fusion spliced with the marker aligned regardless of the fiber direction, it is not necessary in the depicted embodiment to distinguish a draw direction of the multicore optical fiber 10. For multicore optical fibers 10 terminated by a connector, the axis of symmetry 20 may be aligned to a connector key, with the marker oriented either toward or away from the connector key.

FIG. 7 depicts an alternative embodiment of the multicore optical fiber 10 in which the cores 16 have a trapezoidal configuration. The trapezoidal configuration uniquely defines the axis of symmetry 20, thereby allowing the marker 18 to be omitted, and also provides symmetric core pairs about the axis of symmetry 20. However, the increased distance between the more widely placed cores 16 may result in a reduced distance between those cores 16 and the outer surface of the cladding 14. This reduced distance may be accommodated, for example, by using a bend insensitive core profile design. In addition to markers and asymmetric core placement, core placement relative to the axis of symmetry 20 may be identified by features on the outer surface of the cladding 14, such as a flat edge. Thus, any feature (e.g., marker, core pattern asymmetry, cladding asymmetry) that identifies a relationship between the cores 16 and the axis of symmetry 20 may be used to orient the multicore optical fiber 10 and identify the cores 16 therein. These features may take an asymmetric form with respect to the axis of symmetry 20 as shown in FIGS. 2-5, or be symmetric about the axis of symmetry 20 as shown in FIGS. 6 and 7.

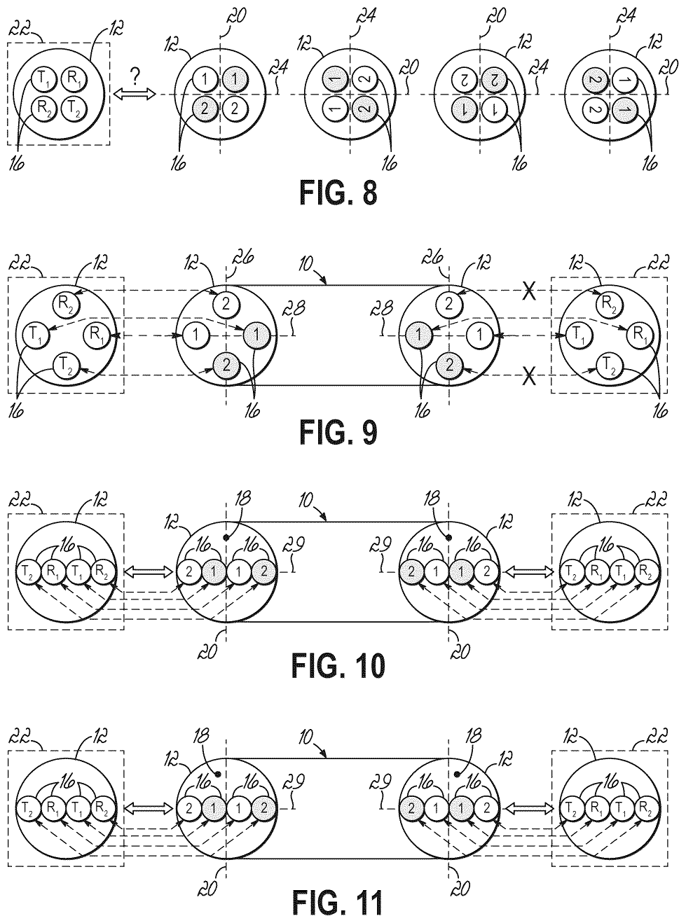

FIG. 8 depicts the connector interface 22 in relation to an end face 12 of multicore optical fiber 10 that lacks a feature which positively identifies the axis of symmetry 20. Based only on the core pattern, two potential axes of symmetry can be identified, the true axis of symmetry 20 and a false axis of symmetry 24. Moreover, the orientation of each axis cannot be distinguished between two possible orientations each 180 degrees From the other. As a result, the correct orientation of the end face 12 can only be defined as being one of four possible orientations each presenting the same core pattern. Thus, FIG. 8 demonstrates that without some asymmetric feature (e.g., a marker, core pattern asymmetry, or cladding asymmetry) the axis of symmetry 20 cannot be uniquely identified for the depicted core pattern. This inability to determine correct core pattern orientation could lead to mismatched transceiver channels, core polarities, or both mismatched transceiver channels and core polarities.

FIG. 9 depicts an embodiment of the multicore optical fiber 10 in which the channel one symmetric core pair is symmetric about one axis of symmetry 26, and the channel two symmetric core pair is symmetric about another axis of symmetry 28 different from (e.g., orthogonal to) the channel one axis of symmetry 26. Because each symmetric core pair has mirror image symmetry about a different axis of symmetry 26, 28, only one core pair (e.g., the channel one symmetric core pair) can support the same core polarity in both the left and right side connector interfaces 22. Accordingly, only a portion of the cores of multicore optical fiber 10 satisfy the bidirectional symmetry requirements.

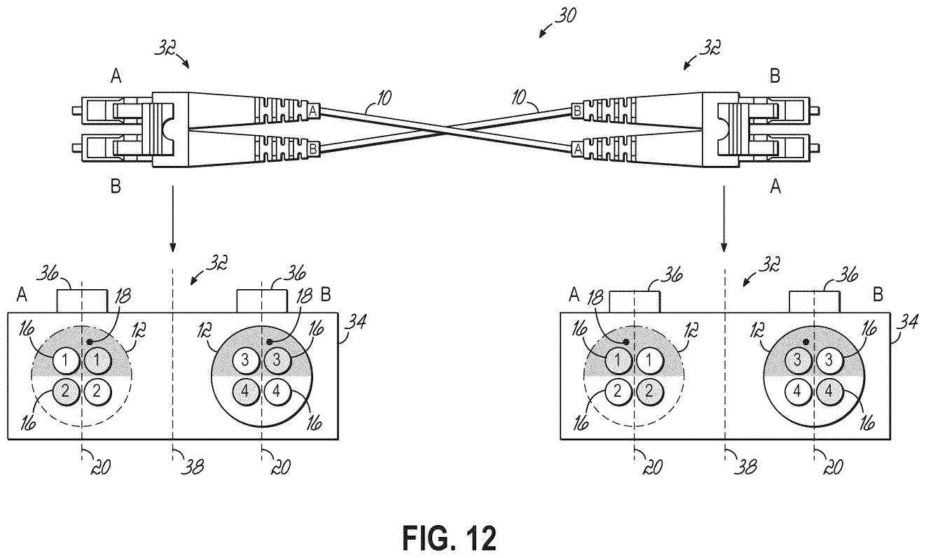

FIGS. 10 and 11 depict embodiments of the multicore optical fiber 10 having four cores 16 in a 1×4 configuration aligned (e.g., colinear) with a cross-axis 29 of end face 12, indicated by a dashed line. The cross-axis 29 of end face 12 may be defined by a line that is orthogonal to the axis of symmetry 20 and in the same plane orthogonal to the longitudinal axis of multicore optical fiber 10 as the axis of symmetry 20. In each figure, the inner symmetric core pair is used for transceiver channel one (T1 and R1) and the outer symmetric core pair is used for transceiver channel two (T2 and R2). FIGS. 10 and 11 demonstrate that there can be more than one symmetric core pair along the same axis, e.g., cross-axis 29.

Because the core spacing of the 1×4 configuration is closer than the core spacing of the 2×2 configuration, the transmit and receive cores may be interleaved to reduce crosstalk. However, in an alternative embodiment, each of the transmit cores 16 could be on one side of the axis of symmetry 20, and each of the receive cores 16 on the other side of the axis of symmetry 20. The sole difference between the multicore optical fibers 10 in FIGS. 10 and 11 is the placement of the marker 18 relative to the core pattern/axis of symmetry 20. In FIG. 10, marker 18 is collinear with the axis of symmetry 20, and in FIG. 11, the marker 18 is offset from the axis of symmetry 20. In each case, the marker fully identifies the placement of both the cores 16 and the axis of symmetry 20.

For connectors that terminate a single multicore optical fiber 10, the optical fiber may be oriented so that the marker 18 is either placed toward or away from the connector key. Parallel single mode transceivers typically have four channels for 400G devices (eight lanes total), and the number of channels is expected to increase (e.g., to eight channels/16 lanes) in order to achieve speeds of 800G and beyond. Accordingly, two four-core optical fibers may be used for 400G and lower speed transceivers, and four four-core optical fibers may be used for higher speeds. For coarse wavelength division multiplexing transceivers which only use two fiber cores, a simplex four-core optical fiber jumper can support two transceivers. The mapping of the transmitter and receiver to the cores of the multicore optical fiber may be similar to that of parallel single mode transceivers, but with each transceiver lane supporting a multiplexed multi-wavelength optical signal.

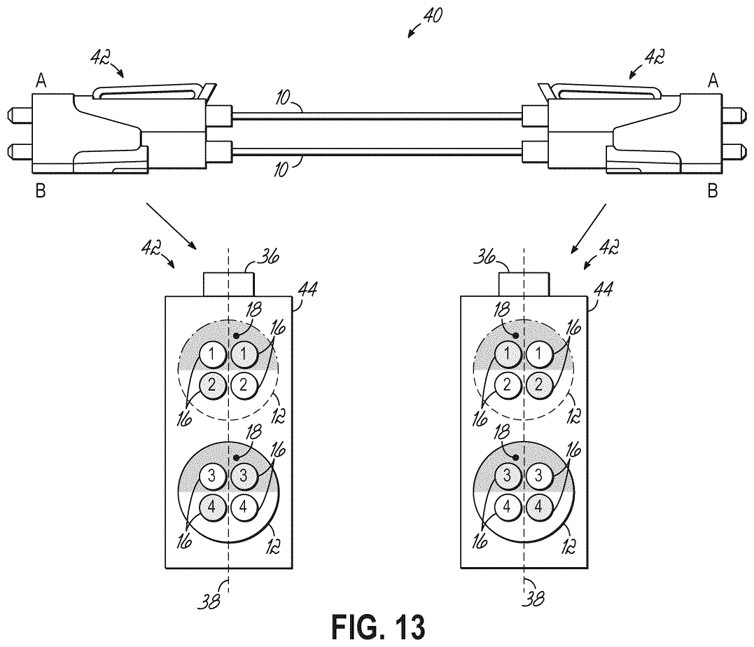

FIGS. 12 and 13 depict two exemplary multicore patch cords 30, 40 each having a standard A-A configuration that may be used for interconnecting a pair of four-lane transceivers. Each multicore patch cord 30, 40 includes a plurality of multicore optical fibers 10 (e.g., two multicore optical fibers 10) each having a plurality of cores 16 (e.g., four cores in a 2×2 configuration) within a common cladding 14 and an axis of symmetry 20. Each end face 12 of each multicore optical fiber 10 is operatively coupled to a respective cable connector 32, 42 that includes a connector interface 34, 44 and one or more alignment keys 36. FIG. 12 depicts a duplex LC connector type interface, which may be considered as two simplex connectors each having a respective alignment key 36. In the embodiment depicted by FIG. 12, the alignment keys 36 of each connector 32 define a key-axis 38 that is located midway between the keys 36. In the embodiment depicted by FIG. 13, the alignment key 36 of each connector 42 defines a key-axis 38 that passes through the alignment key 36. In the depicted embodiments, the end faces 12 are placed within the connector interface 34, 44 so that the marker 18 of each end face 12 is oriented toward the side of the connector 32, 42 including the one or more alignment keys 36. This orientation may be referred to as “toward the alignment key”, and results in the axis of symmetry 20 of each end face 12 being aligned with the key-axis 38. For the cable connector 32 of multicore patch cord 30, the axis of symmetry 20 is aligned with the key-axis 38 because the axis of symmetry 20 is parallel to the key-axis 38. For the cable connector 42 of multicore patch cord 40, the axis of symmetry 20 is aligned with the key-axis 38 because the axis of symmetry 20 is colinear with the key-axis 38. Thus, the axis of symmetry 20 of an end face 12 is considered to be “aligned” with a key-axis 38 of a connector interface if the axes are oriented in the same direction, e.g., are in parallel or colinear. Other orientations of the marker 18 that result in alignment of the axis of symmetry 20 with the key-axis 38 may be used, such as away from the side of the connector 32, 42 including the alignment key 36, i.e., “away from the alignment key”. For purposes of illustration only, and to facilitate identification of the orientation of each end face 12 in figures having a wider perspective, the portion of the end face 12 in which the marker is located may be shaded as shown in FIGS. 12 and 13.

The cable connectors 32, 42 are configured so that, in operation, each core 16 receives one or more optical signals from, or transmits one or more optical signal to, a port connector (not shown) at one end of the multicore optical fiber 10. Each core 16 transmits the one or more received optical signals to, or receives the one or more transmitted optical signals from, another port connector (not shown) at the other end of the multicore optical fiber 10. The depicted multicore patch cords 30, 40 would enable a pair of 8-lane transceivers to be connected using two duplex jumpers, and allow multiple duplex jumpers to be cascaded with the same core polarity effect as a single duplex jumper.

FIG. 12 depicts the connector 32 as an LC duplex connector including end faces 12 having a horizontal relationship with the key-axis 38. To maintain a consistent channel polarity at each end of multicore patch cord 30, the multicore optical fibers 10 have a crossover configuration. FIG. 13 depicts the connector 42 as a Very Small Form Factor (VSFF) connector (e.g., MDC connector or SN connector according to the QSFP-DD Multi-Source Agreement (MSA) Hardware Specification, Rev. 6.3, 2022, and the relevant documents cross-referenced therein) including end faces 12 having a vertical relationship with the key-axis 38. In contrast to multicore patch cord 30 of FIG. 12, a consistent channel polarity is maintained at each end of multicore patch cord 40 by the multicore optical fibers 10 having a straight-through configuration.

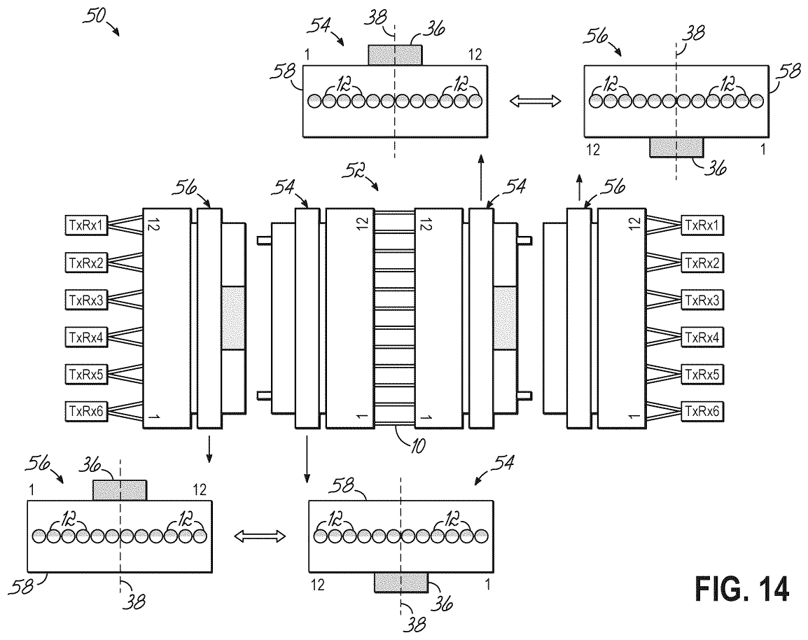

FIG. 14 depicts an exemplary multicore structured cabling system 50 including a bidirectional symmetric multicore fiber optic trunk cable 52 terminated at each end by a cable connector 54 configured to engage a matching port connector 56. The cable connectors 54 may be, for example, MPO array connectors configured to provide duplex paths for each of a plurality of multi-lane transceivers (e.g., each MPO array connector providing six duplex paths, with each path corresponding to a four-lane transceiver to result in 48 total lanes). Each cable connector 54 and port connector 56 may include a connector interface 58 that includes a plurality of end faces 12 (e.g., 12 end faces) arranged in a linear array (i.e., a “row”) generally orthogonal to the key-axis 38 of the connector 54, 56. The end faces 12 of multicore optical fibers 10 may also be arranged in the connector interfaces 58 based on TIA-568 Method-A in order to preserve fiber polarity. Each end face 12 may be placed in its respective connector interface 58 so that the markers 18 (if present) are oriented in one direction (e.g., toward the alignment key 36) in the key up connectors 54, 56, and in the opposite direction (e.g., away from the alignment key 36) in the key down connectors 54, 56.

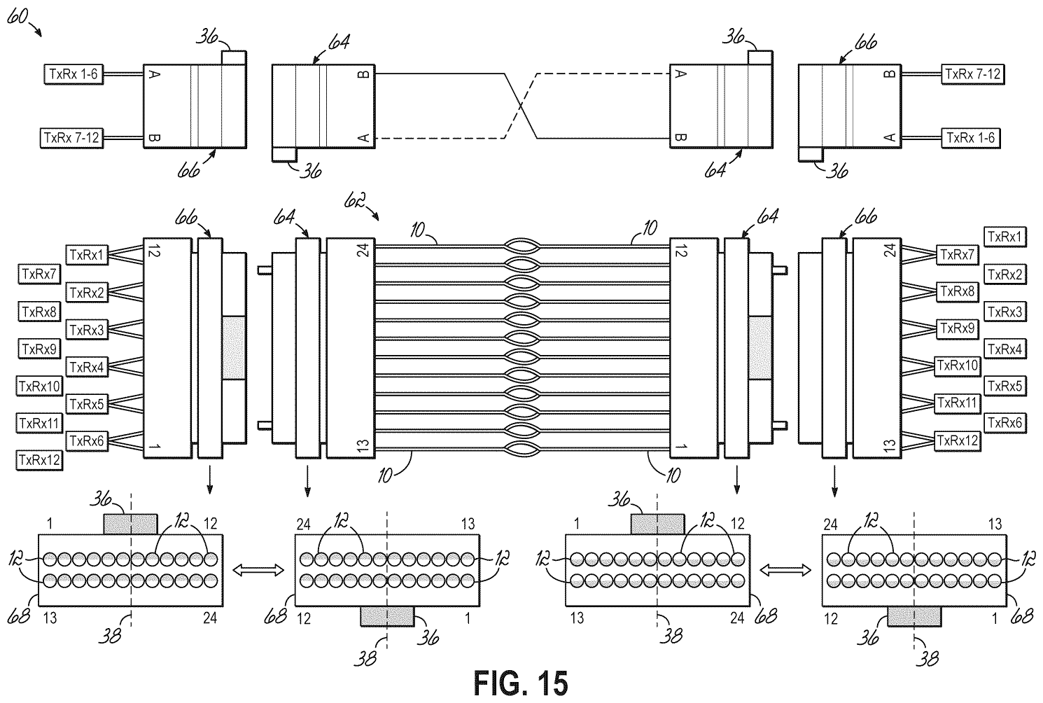

FIG. 15 depicts an exemplary multicore structured cabling system 60 including a bidirectional symmetric multicore fiber optic trunk cable 62 terminated at each end by a cable connector 64 configured to engage a matching port connector 66. As with trunk cable 52 of FIG. 14, the cable connectors 64 may be MPO array connectors configured to provide duplex lanes for each of a plurality of multi-lane transceivers (e.g., each MPO array connector providing twelve duplex paths, with each path corresponding to a four-lane transceiver to result in 96 total lanes). Each cable connector 64 and port connector 66 may include a connector interface 68 having a plurality of end faces 12 (e.g., 24 end faces) arranged in a plurality of rows (e.g., two rows) each generally orthogonal to the key-axis 38 of the connector 64, 66. The end faces 12 of multicore optical fibers 10 may be arranged in the connector interfaces 68 based on TIA-568 Method-A in order to preserve fiber polarity. Each end face 12 may be placed in its respective connector interface 68 so that the markers 18 (if present) are oriented in one direction (e.g., toward the alignment key 36) in the port connectors 66, and in the opposite direction (e.g., away from the alignment key 36) in the cable connectors 64. The connectors 64, 66 of multicore structured cabling system 60 demonstrate the scalability of structured cabling systems using multi-row ferrules. Each row of ferrules may be, for example, associated with one of two multicore fiber optic ribbon cables that are parallel to each other in the trunk cable.

Single mode MPO ferrules typically have an end face that is angled to optimize return loss. So that these opposing end faces are parallel to each other when two connectors are engaged, mating adaptors may be configured to support key up to key down engagement. Accordingly, an MPO connector for a breakout assembly may need to match to each end of the trunk cable. Thus, in the depicted multicore structured cabling systems 50, 60, there may be two types of multicore fiber connector orientations, one for key up connectors and another for key down connectors.

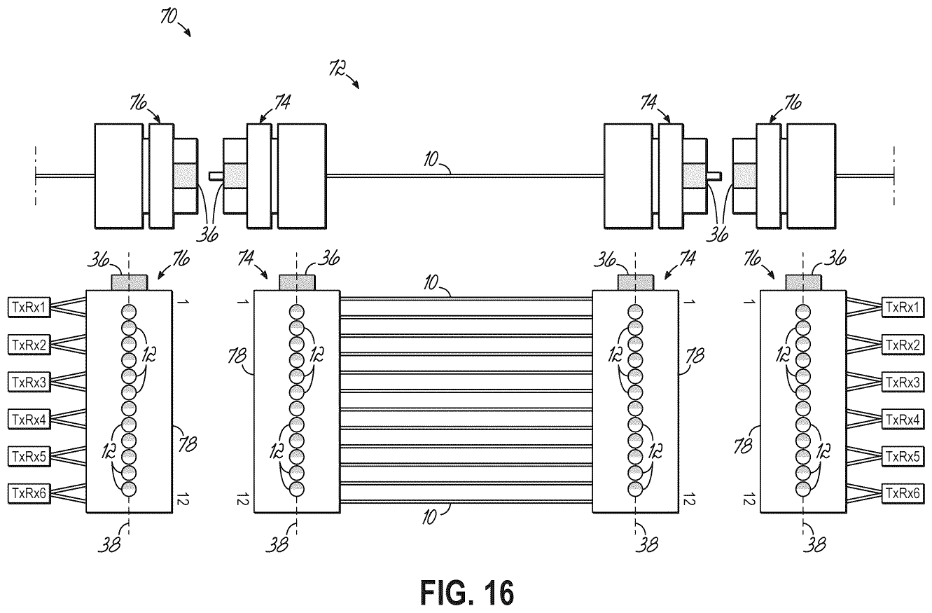

FIG. 16 depicts side and top views illustrating another exemplary multicore structured cabling system 70. The cabling system 70 includes a bidirectional symmetric multicore fiber optic trunk cable 72 terminated at each end by a cable connector 74 configured to engage a matching port connector 76 (e.g., an MMC connector offered by US Conec Ltd. or SN-MT connector offered by Senko Advanced Components, Inc.). Rather than using row connectors such as depicted in FIGS. 14 and 15, the connectors 74, 76 of cabling system 70 have connector interfaces 78 in which the end faces 12 of the multicore optical fibers 10 are arranged in linear arrays (i.e., columns) parallel to the key-axis 38. Aligning a column of end faces 12 with the key-axis 38 with the marker 18 of each end face oriented toward the alignment key 36 results in identical connector interfaces 78 at each end of the trunk cable 72. Port connectors 76 (e.g., for breakout modules) may therefore be configured to have the same connector interface 78 as the cable connectors 74.

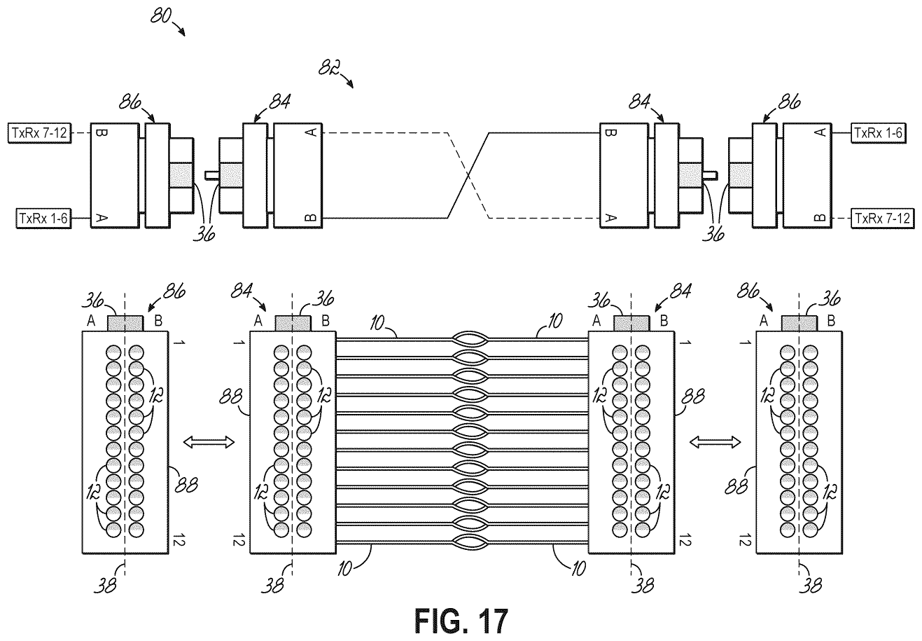

FIG. 17 depicts side and top views of illustrating another exemplary multicore structured cabling system 80. The cabling system 80 includes a bidirectional symmetric multicore fiber optic trunk cable 82 terminated at each end by a cable connector 84 configured to engage a matching port connector 86. The connectors 84, 86 of cabling system 80 have connector interfaces 88 in which the end faces 12 of multicore optical fibers 10 are arranged in a plurality of columns (e.g., two columns) each parallel to the key-axis 38. To maintain a consistent channel polarity at each end of trunk cable 82, the multicore optical fibers 10 have a crossover configuration that swaps the end faces 12 between columns at the cable connectors 84. This swapping of end faces 12 is similar to the swapping of end faces 12 in multicore patch cord 30 of FIG. 12, only repeated for each pair of multicore optical fibers 10 on opposite sides of the key-axis 38. In this regard, the connector interface 88 may be viewed as a plurality of the connector interfaces 34 of FIG. 12 stacked one on top of the other.

To provide the above crossover feature without incurring a macro bend loss, the multicore optical fibers 10 of trunk cable 82 may be formed into conventional encapsulated ribbons, and the crossing point of the two ribbons located outside the trunk cable. The preferred locations can be in the furcation point of the trunk cable or inside one of the column connectors 84, where the ribbon can be locally de-ribbonized at the crossing point. If the multicore optical fibers 10 are grouped into rollable ribbons, the ribbon crossing may be provided by a fiber optic cable connecting the trunk cable 82 to a breakout module or other network component without posing a risk of macro bend loss.

As with the single column connector interfaces 78 of FIG. 16, the multi-column connector interfaces 88 are identical at each end of the trunk cable 82 so that port connectors 86 can be configured to have the same connector interface 88 as the cable connectors 84. The connectors of FIGS. 16 and 17 support angled physical contact, and provide the advantage of having the same connector interface at each end of the trunk cable 72, 82. Having the same connector interface at each end of the trunk cable 72, 82 eliminates the need for additional part numbers such as may be required in the MPO row connector based solutions of FIGS. 14 and 15.

Cabling system 80 demonstrates that multiple column ferrules or ganged multiple column connectors can support higher fiber count applications. The above column-based connector configurations may be scaled to accommodate larger numbers of multicore optical fibers by increasing the length of the columns, or by adding additional columns. For example, 16 multicore optical fibers may be accommodated in an MMC connector. Column connectors may also be scaled down to less than 12 multicore optical fibers, e.g., to one or two multicore fibers in an MMC connector. This would provide a practical way to make multicore fiber duplex connectors as compared to using MDC connectors, which have a simplex multicore optical fiber design that may be less precise at controlling ferrule rotation angles.

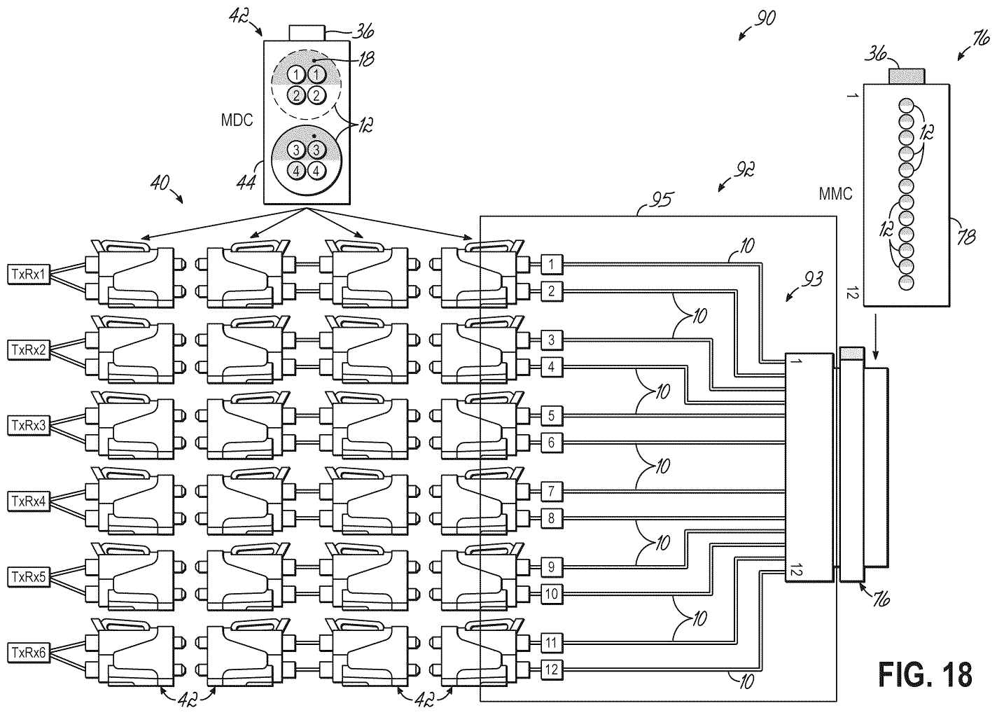

FIG. 18 depicts another exemplary structured multicore fiber optic cabling system 90. The cabling system 90 includes a breakout module 92 and a plurality of the A-to-B multicore patch cords 40 depicted by FIG. 13. The breakout module 92 includes a cabling harness 93 and a housing 95 that encloses the cabling harness 93 and provides a surface for mounting connectors. The cabling harness 93 includes the port connector 76 of FIG. 16 (which has a column configuration) and a plurality of branch connectors 42 (e.g., six branch connectors). The trunk-side port connector 76 is operatively coupled to the branch connectors 42 by paired multicore optical fibers 10 having bidirectional symmetry. The branch connectors 42 may be MDC connectors, for example, and may configured to engage the cable connectors 42 of multicore patch cords 40. The trunk-side port connector 76 can support a total of 12 multicore optical fibers 10, with two multicore optical fibers 10 being operatively coupled to each branch connector 42. However, embodiments are not limited to any particular number of multicore optical fibers or types of connectors.

Each multicore optical fiber pair is depicted as being terminated by a duplex connector, however, other types of connectors may be used. Due to the bidirectional symmetric properties of the multicore fiber and transceiver assignment, cascading connectors and splices of the multicore fiber does not disrupt core polarity. This robust core polarity is due at least in part to the intrinsic core polarity management provided by the bidirectional symmetry of the structured multicore fiber optic cabling system 90. The structured multicore fiber optic cabling system 90 may be modified for use with coarse wavelength division multiplexing based and other types of transceivers. The breakout module 92 may also be modified to breakout optical signals to simplex connectors or other types of connectors.

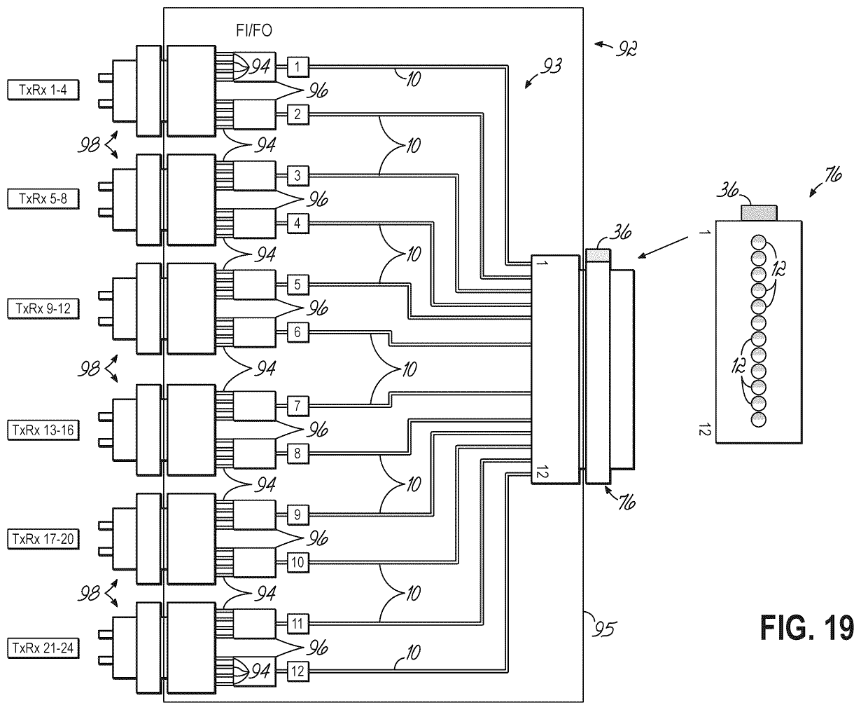

FIG. 19 depicts an alternative embodiment of the breakout module 92 in which each multicore optical fiber 10 is operatively coupled to a plurality of single core optical fibers 94 by a respective fan-in/fan-out module 96. Each of two multicore fiber fan-in/fan-out modules 96 may be operatively coupled to a plurality of single core optical fibers 94 (e.g., four optical fibers 94) that are cross-connected and terminated by a branch connector 98. Although the port connector 76 is depicted as having the end faces 12 of multicore optical fibers 10 arranged in a single column, alternative embodiments of the breakout module 92 may include a multi-column connector, or an MPO connector with the end faces 12 arranged in one or more rows. The depicted configuration may be used with standard single mode transceiver modules, and is compatible with both parallel single mode and coarse wavelength division multiplexing transceivers. The receive and transmit modules of each transceiver may be multiplexed into the multicore optical fibers 10 by fan-in/fan-out modules 96 based on any of the core assignment schemes described above. The multicore optical fibers 10 from the fan-in/fan-out modules 96 may then be terminated in the port connector 76 using a consistent polarity scheme.

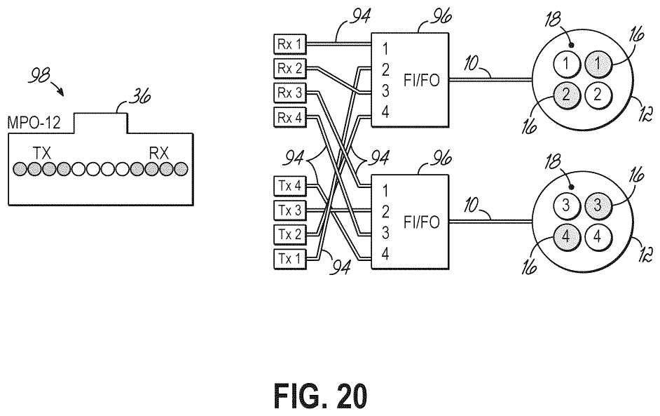

FIG. 20 depicts one of the exemplary fan-in/fan-out modules 96 of FIG. 19 in greater detail. The fan-in/fan-out module 96 may be used with parallel single mode transceivers, such as a quad small form factor 28 G data rate (QSFP28) transceiver with an MPO-12 interface. Each of two multicore fiber fan-in/fan-out modules 96 may be operatively coupled to a plurality of single core optical fibers 94 (e.g., four optical fibers 94) that are cross-connected and terminated by an MPO-12 connector 98. In a similar manner, 8-lane parallel single mode transceivers may be mapped by two MPO-12 connectors, an MPO-24 connector, or an MPO-16 connector into four multicore fiber fan-in/fan/out modules 96. Using array fan-in/fan-out modules may eliminate the need for duplex multicore fiber connectors. All the multicore fiber connectors in the solutions can be simplified to a single column connector format. There are many variations in the bidirectional symmetric multicore fiber solutions within the scope of this disclosure. For example, multiple spans of trunk cables or multiple spans of interconnect array jumpers may be used instead of a single trunk span, and array column connectors are the same on each side of a termination. The multicore fiber duplex jumpers or array jumpers can also be used to cross-connect two or more trunk cable systems.

Accordingly, while the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The present disclosure in its broader aspects is therefore not limited to the specific details, representative apparatus and methods and illustrative examples shown and described. Accordingly, departures may be made from such details without departing from the scope of the present disclosure.

What is claimed is:

1. A structured bidirectional symmetric multicore fiber optic cabling system, comprising:
a first multicore optical fiber including a first end face having a first axis of symmetry, a second end face having a second axis of symmetry, and a plurality of cores that define a first end face core pattern at the first end face that is symmetric about the first axis of symmetry and a second end face core pattern at the second end face that is symmetric about the second axis of symmetry;
a first connector operatively coupled to the first end face and including a first connector interface having a first key-axis and a first connector core pattern defined at least in part by the first end face core pattern;
a second connector operatively coupled to the second end face and including a second connector interface having a second key-axis and a second connector core pattern defined at least in part by the second end face core pattern;
a third connector configured to engage the first connector and including a third connector interface having a third key-axis and a third connector core pattern that matches the first connector core pattern; and
a fourth connector configured to engage the second connector and including a fourth connector interface having a fourth key-axis and a fourth connector core pattern that matches the second connector core pattern, wherein
the first end face core pattern includes a first core and a second core placed symmetrically about the first axis of symmetry,
the second end face core pattern includes the first core and the second core placed symmetrically about the second axis of symmetry,
the third connector core pattern includes a third core and a fourth core placed symmetrically about a third axis of symmetry aligned with the third key-axis,
the fourth connector core pattern includes a fifth core and a sixth core placed symmetrically about a fourth axis of symmetry aligned with the fourth key-axis,
the first connector interface and the third connector interface are configured so that, when the first connector and the third connector are engaged, the first core receives a first optical signal from the third core and the second core transmits a second optical signal to the fourth core, and
the second connector interface and the fourth connector interface are configured so that, when the second connector and the fourth connector are engaged, the first core transmits the first optical signal to the fifth core and the second core receives the second optical signal from the sixth core.

2. The cabling system of claim 1, wherein:
the first connector includes a first alignment key that defines the first key-axis,
the second connector includes a second alignment key that defines the second key-axis, and
the first end face has the same orientation relative to the first alignment key as the second end face has relative to the second alignment key.

3. The cabling system of claim 1, wherein each of the first end face and the second end face further includes an asymmetric feature that identifies one core of the plurality of cores as a reference core.

4. The cabling system of claim 3, wherein the asymmetric feature is provided by one or more of a marker, a core pattern asymmetry, or a cladding asymmetry.

5. The cabling system of claim 4, wherein the asymmetric feature is provided by the marker, and the marker is placed on the first axis of symmetry at the first end face and on the second axis of symmetry at the second end face.

6. The cabling system of claim 1, wherein the first multicore optical fiber is one of a plurality of multicore optical fibers arranged into one or more linear arrays in each of the first connector interface and the second connector interface to respectively define the first connector core pattern and the second connector core pattern.

7. The cabling system of claim 6, wherein:
the one or more linear arrays in the first connector interface are orthogonal to the first key-axis,
the one or more linear arrays the second connector interface are orthogonal to the second key-axis,
a first half of the plurality of multicore optical fibers in each of the one or more linear arrays is on one side of the first key-axis in the first connector interface and on one side the second key-axis in the second connector interface, and
a second half of the plurality of multicore optical fibers in each of the one or more linear arrays is on the other side of the first key-axis in the first connector interface and on the other side of the second key-axis in the second connector interface.

8. The cabling system of claim 6, wherein:
the one or more linear arrays in the first connector interface are aligned with the first key-axis, and
the one or more linear arrays the second connector interface are aligned with the second key-axis.

9. The cabling system of claim 8, wherein the one or more linear arrays includes a single array colinear with the first key-axis in the first connector interface and a single array colinear with the second key-axis in the second connector interface.

10. The cabling system of claim 8, wherein the one or more linear arrays includes an even number of arrays parallel to and having mirror-image symmetry about the first key-axis in the first connector interface, and an even number of arrays parallel to and having mirror-image symmetry about the second key-axis in the second connector interface.

11. A method of making a multicore fiber optic cabling system, comprising:
providing a first multicore optical fiber including a first end face having a first axis of symmetry, a second end face having a second axis of symmetry, and a plurality of cores that defines a first end face core pattern at the first end face that is symmetric about the first axis of symmetry and a second end face core pattern at the second end face that is symmetric about the second axis of symmetry, wherein the first end face core pattern includes a first core and a second core placed symmetrically about the first axis of symmetry and the second end face core pattern includes the first core and the second core placed symmetrically about the second axis of symmetry;
operatively coupling a first connector to the first end face, the first connector including a first connector interface having a first key-axis and a first connector core pattern defined at least in part by the first end face core pattern;
operatively coupling a second connector to the second end face, the second connector including a second connector interface having a second key-axis and a second connector core pattern defined at least in part by the second end face core pattern;
configuring a third connector to engage the first connector, the third connector including a third connector interface having a third key-axis and a third connector core pattern that matches the first connector core pattern and includes a third core and a fourth core placed symmetrically about a third axis of symmetry aligned with the third key-axis;
configuring a fourth connector to engage the second connector, the fourth connector including a fourth connector interface having a fourth key-axis and a fourth connector core pattern that matches the second connector core pattern and includes a fifth core and a sixth core placed symmetrically about a fourth axis of symmetry aligned with the fourth key-axis;
configuring the first connector interface and the third connector interface so that, when the first connector and the third connector are engaged, the first core receives a first optical signal from the third core and the second core transmits a second optical signal to the fourth core, and
configuring the second connector interface and the fourth connector interface so that, when the second connector and the fourth connector are engaged, the first core transmits the first optical signal to the fifth core and the second core receives the second optical signal from the sixth core.

12. The method of claim 11, wherein the first connector includes a first alignment key that defines the first key-axis, wherein the second connector includes a second alignment key that defines the second key-axis, and wherein the method further comprises:
placing the first end face in the first connector and the second end face in the second connector so that the first end face has the same orientation relative to the first alignment key as the second end face has relative to the second alignment key.

13. The method of claim 11, further comprising:
configuring each of the first end face and the second end face to include an asymmetric feature that identifies one core of the plurality of cores as a reference core.

14. The method of claim 13, wherein the asymmetric feature is provided by one or more of a marker, a core pattern asymmetry, or a cladding asymmetry.

15. The method of claim 14, wherein the asymmetric feature is provided by the marker, and further comprising:
placing the marker on the first axis of symmetry at the first end face; and
placing the marker on the second axis of symmetry at the second end face.

16. The method of claim 11, wherein the first multicore optical fiber is one of a plurality of multicore optical fibers, and wherein the method further comprises:
arranging the plurality of multicore optical fibers into one or more linear arrays in the first connector interface to define the first connector core pattern; and
arranging the plurality of multicore optical fibers into the one or more linear arrays in the second connector interface to define the second connector core pattern.

17. The cabling system of claim 16, wherein:
arranging the plurality of multicore optical fibers into the one or more linear arrays in the first connector interface includes arranging the one or more linear arrays:
to be orthogonal to the first key-axis,
so that a first half of the plurality of multicore optical fibers in each of the one or more linear arrays is on one side of the first key-axis, and
so that a second half of the plurality of multicore optical fibers in each of the one or more linear arrays is on the other side of the first key-axis; and
arranging the plurality of multicore optical fibers into the one or more linear arrays in the second connector interface includes arranging the one or more linear arrays:
to be orthogonal to the second key-axis,
so that the first half of the plurality of multicore optical fibers in each of the one or more linear arrays is on one side of the second key-axis, and
so that the second half of the plurality of multicore optical fibers in each of the one or more linear arrays is on the other side of the second key-axis.

18. The method of claim 16, wherein:
arranging the plurality of multicore optical fibers into the one or more linear arrays in the first connector interface includes arranging the one or more linear arrays to be aligned with the first key-axis, and
arranging the plurality of multicore optical fibers into the one or more linear arrays in the second connector interface includes arranging the one or more linear arrays to be aligned with the second key-axis.

19. The method of claim 18, wherein the one or more linear arrays includes a single array colinear with the first key-axis in the first connector interface and colinear with the second key-axis in the second connector interface.

20. The cabling system of claim 18, wherein the one or more linear arrays includes an even number of arrays parallel to, and having mirror-image symmetry about, the first key-axis in the first connector interface and the second key-axis in the second connector interface.
